(19) United States
(12) Patent Application Publication
(10) Pub. No.: US 2012/0242165 A1
(43) Pub. Date: Sep. 27, 2012

(54) METHOD AND DEVICE FOR TRANSMITTING ELECTRIC POWER FROM A WALL TO A LEAF HINGEABLY FASTENED TO SAID WALL

(75) Inventors: Tibor Herglotz, Kreuzau (DE); Ingo Steinfeld, Langenfeld (DE); Wolfgang Staude, Waldeck (DE)

(73) Assignees: Staude Kunststofftechnik GmbH, Bad Arolsen (DE); Dr. Hahn GmbH & Co. KG, Moenchengladbach-Wickrath (DE)

(21) Appl. No.: 13/512,891

(22) PCT Filed: Oct. 4, 2010
(86) PCT No.: PCT/EP2010/064728

§ 371 Date: May 31, 2012

(30) Foreign Application Priority Data
Dec. 2, 2009 (DE) 10 2009 044 728.8

(51) Int. Cl. H01F 38/14

(52) U.S. Cl. 307/104

(57) ABSTRACT

A method for transmitting electric power from a wall to a door hingeably attached to the wall about a hinge axis (S) includes providing a primary coil on the wall. A secondary coil is provided on the door. An electrical primary voltage is made available on a wall side. The electrical primary voltage has a primary frequency that is suitable for acting on the primary coil. A secondary voltage of at least 500 mV is generated in the secondary coil by an inductive coupling.

### CROSS REFERENCE TO PRIOR APPLICATIONS

This application is a U.S. National Phase application under 35 U.S.C. §371 of International Application No. PCT/EP2010/064728, filed on Oct. 4, 2010 and which claims benefit to German Patent Application No. 10 2009 044 728.8, filed on Dec. 2, 2009. The International Application was published in German on Jun. 9, 2011 as WO 2011/067010 A2 under PCT Article 21(2).

### FIELD

The present invention provides a method and a device for transmitting electric power from a wall to a door hingeably attached to this wall, about a hinge axis S.

### BACKGROUND

Door hinges that serve for a hingeable connection of a door to a wall have already been known for a long time, for example, from DE 93 02 652 U1. They have proven themselves many times in different technical embodiments, and are also used on doorways for buildings such as houses, businesses, or also for escape doorways.

Such doorways increasingly have installations that improve safety or convenience, which installations are operated by means of electrical energy.

For providing energy, these installations are connected with an external energy source by way of flexible cables.

These cable connections clearly impair the optical appearance and can become jammed between the door and the wall, and this can lead to damage to or even destruction of the cables.

A door hinge having a built-in transformer for contact-free energy transmission is described in DE 10 2004 017 341 A1. This door hinge comprises a primary coil disposed in a frame hinge part and a secondary coil disposed in a door hinge part. A door hinge pin that passes through the two coils serves for magnetic coupling of the secondary coil with the primary coil, which are spaced apart from one another in the direction of the hinge axis.

Contact-free energy transmission from a fixed frame to a door pivotably disposed on the frame is fundamentally desirable to avoid the disadvantages mentioned above, but experiments have shown that only very slight electrical power can be transmitted from the primary to the secondary side using the door hinge described in DE 10 2004 017 341 A1 because the power loss during transmission is very high.

### SUMMARY

An aspect of the present invention is to provide a method and a device for transmitting electrical energy from a wall to a door hingeably attached to the wall, about a hinge axis, in order to bring about a contact-free transmission of electrical energy at least at a power such as is required for charging an electrical energy storage unit and/or an electrical consumer.

In an embodiment, the present invention provides a method for transmitting electric power from a wall to a door hingeably attached to the wall about a hinge axis (S) which includes providing a primary coil on the wall. A secondary coil is provided on the door. An electrical primary voltage is made available on a wall side. The electrical primary voltage has a primary frequency that is suitable for acting on the primary coil. A secondary voltage of at least 500 mV is generated in the secondary coil by an inductive coupling.

### BRIEF DESCRIPTION OF THE DRAWINGS

The present invention is described in greater detail below on the basis of embodiments and of the drawings in which:

FIG. 1 shows an exploded view of an embodiment of a device according to the present invention, which simultaneously has the function of a conventional door hinge;

FIG. 2 shows the device in a partly torn-apart representation of the wall and door parts, in a perspective representation, with schematically indicated primary and secondary electronics;

FIG. 3 shows the upper wall part and the door part, partly torn apart, in a perspective individual representation;

FIG. 4 shows a front view of the open face side of a coil body;

FIG. 5 shows the detail V in FIG. 2 in section through the hinge axis; and

FIG. 6 shows an exploded representation of an embodiment of the device according to the present invention, which serves only for transmitting electric power from a wall to a door.

### DETAILED DESCRIPTION

In an embodiment, the method according to the present invention for transmitting electrical energy from a wall to a door hingeably attached to the wall, about a hinge axis, provides for making available an electrical primary voltage on the wall side, having a primary frequency that is suitable for acting on a primary coil provided on the wall, in order to generate a secondary voltage of up to at least 500 mV power in a secondary coil provided on the door, by means of inductive coupling. According to the present invention, this is provided not solely by selecting the configuration and placement of the primary coil and the secondary coil in such a manner so that sufficient power can be transmitted with an existing voltage, for example the grid voltage, but rather also by means of adapting the primary voltage and the primary frequency.

In an embodiment of the present invention, the primary voltage can, for example, have a frequency that amounts to at least 20 kHz. In this way, it is avoided that other components are put into mechanical vibration in the audible range by means of the electromagnetic field generated by the primary coil.

In an embodiment of the present invention, the primary frequency can, for example, amount to between 50 and 140 kHz. It is then situated far above the audible range and is not yet in such a high frequency range in which emission of radio waves by the feed lines, which could disrupt radio transmission in the long-wave range, must be expected.

In an embodiment of the present invention, the primary voltage that is applied to the primary coil can, for example, amount to maximally 48 V. Because of this limitation, on the one hand, the minimal power of 500 mV can be transmitted using the method according to the present invention without the primary coil having a disadvantageous size for this purpose of use, and on the other hand, it is possible to do without safety measures that would be necessary to protect people from electrical shock in the case of higher primary voltages, because voltages up to the maximal value mentioned are not dangerous for people.

In an embodiment of the present invention, the primary voltage can, for example, amount to between 3.5 and 15 V. A coil designed for this voltage range has even smaller dimensions, so that it is better suited for being accommodated on a door hinge that simultaneously serves to transfer mechanical forces between door and wall. Most electrical consumers provided on a door furthermore operate in this voltage range so that the same components can be used for the primary coil and the secondary coil, while still not requiring a transformer following the secondary coil. All that is necessary in this case is rectification of the alternating voltage induced in the secondary coil, because alternating voltage is not suitable for charging an electrical energy storage unit.

In an embodiment of the method according to the present invention, however, if the corresponding selection of the primary voltage is not possible, the secondary voltage generated by the secondary coil is converted to an electrical operating voltage suitable for an electrical energy storage unit and/or for an electrical consumer.

In order to generate the primary voltage at the required primary frequency on the wall side, an existing grid voltage can, for example, be converted accordingly. However, it is also possible to convert a direct voltage, made available by a sabotage-protected, emergency-power-buffered power supply, to the primary voltage, by means of an inverter.

The device according to the present invention for transmitting electric power from a fixed wall to a door hingeably attached to the wall, about a hinge axis, therefore has a wall part that can be attached to the wall, a door part that can be attached to the door, a primary coil provided on the wall part, and a secondary coil provided on the door part, where the primary and secondary coil are suitable for frequencies of at least 20 kHz.

In order to improve the inductive coupling of the secondary coil to the primary coil, the primary coil can, for example, comprise a primary coil winding and a primary coil body having ferromagnetic or ferrimagnetic properties, for example, made of a ferromagnetic or ferrimagnetic material, and the secondary coil can, for example, comprise a secondary coil winding and a secondary coil body having ferromagnetic or ferrimagnetic properties, for example, made of a ferromagnetic or ferrimagnetic material.

The primary coil body can cover the coil winding on the face side that faces the door part, at least almost completely, and can be open on the opposite face side, and the secondary coil body can cover the coil winding on the face side that faces the wall part, at least almost completely, and can be open on the opposite face side.

To improve the coupling and also for easier windability of the coil, a primary coil body and/or a secondary coil body that has an inner, cylindrical mantle surface, around which the primary coil winding or the secondary coil winding, respectively, is wound can, for example, be used.

It is furthermore advantageous to further improve the inductive coupling of the secondary coil to the primary coil, and also to make the coils more resistant to outside influences, if the primary coil body and/or the secondary coil body comprise(s) an outer mantle surface that is disposed concentric to the inner mantle surface. The coil winding is then protected and surrounded by the inner and the outer mantle surface and by the closed face side.

On the basis of the frequency range that the primary voltage preferably has, the primary coil winding and the secondary coil winding can, for example, consist of high-frequency stranded wire.

The device according to the present invention can be configured in such a manner that it serves exclusively for transmitting electrical energy from a wall to a door hingeably attached to this wall, about a hinge axis, and not for the transfer of mechanical forces. In such a case, the actual attachment of the door to the wall takes place exclusively using at least two other, conventional door hinges. Seen radially to the inside from the inner mantle surface, the primary and the secondary coil body can then be configured to be solid.

In an embodiment of the device according to the present invention, the primary and secondary coil body each comprise an opening that extends approximately concentric to the inner mantle surface, in the direction of the hinge axis, through which openings a door hinge pin that defines the hinge axis can be pushed. The device can then serve not only to transfer power but also to transfer mechanical forces between door and wall, and therefore take over the conventional door hinge function at the same time.

In order for the pin to then also act as a common core of a transformer formed using the primary coil and the secondary coil, in order to further improve the inductive coupling, it has a sleeve having ferromagnetic or ferrimagnetic properties, for example made of a ferromagnetic or ferrimagnetic material, on the length that is covered by the primary and by the secondary coil. Its length can, for example, be adapted as precisely as possible to the length that is covered by the primary and by the secondary coil, in order to avoid losses.

In an embodiment of the present invention, the sleeve can be pushed onto the pin. However, the sleeve can, for example, be provided in a recess that runs concentric to the longitudinal axis of the pin. It is then, for example, made from a plastic material having ferrite particles because the unit of pin and sleeve can then be produced in particularly simple manner.

In order to provide good inductive coupling between the primary coil and the secondary coil, at least one of the primary and secondary coils is mounted in the wall part or the door part, respectively, so that it can be displaced, under spring force, against the other coil, in each instance, in the direction of the hinge axis. On the basis of this measure, it is provided that the face sides of the two coils, which sides face one another, are always in direct contact. This is important because it has surprisingly been shown that even when pins with a sleeve are present, even slight gap dimensions lead to significant deterioration of the power transmission from the primary to the secondary coil.

In an embodiment of the present invention, the coil can, for example, have a length that is less than the outside diameter of its coil housing. Particularly if the device according to the present invention is also supposed to serve for transfer of mechanical forces, the pin can be mechanically mounted over a greater length in order to thereby achieve the lowest possible material stress.

If the primary coil and the secondary coil are, for example, configured with the same construction, the costs for production and inventory-keeping of the coils can be reduced.

Experiments have shown that a power transmission of at least 500 milliwatts at a primary voltage of 5 V and a primary frequency of about 120 kHz can already be achieved if the inductivities of primary coil and secondary coil amount to, for example, about 30 μH.

In order to prevent that parts of the device have the primary coil voltage applied to them in the event of an internal short-circuit of a coil, the primary coil and/or the secondary coil, particularly their face sides that face one another, can, for example, be surrounded with an electrically insulating material with material fit.

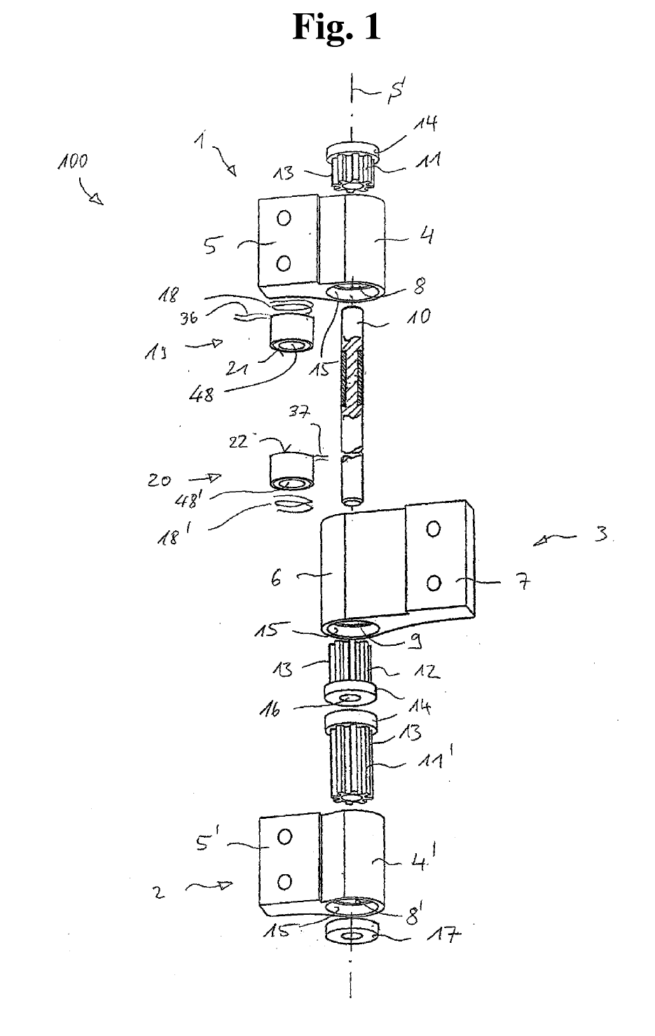

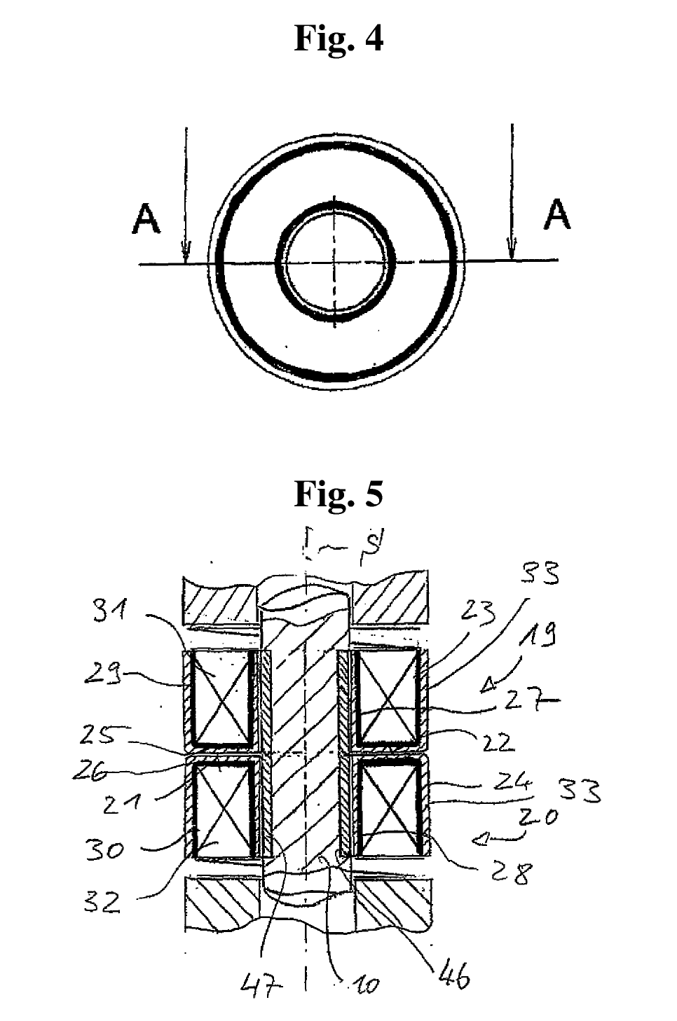

The device indicated as a whole with 100 in FIGS. 1 to 5 is configured as a so-called three-part door hinge. It comprises an upper wall part 1 and a lower wall part 2. The two parts 1, 2 are spaced apart from one another in the direction of a hinge axis S.

A door part 3 is disposed between the upper and the lower wall part 1, 2.

The upper and lower wall parts 1, 2 comprise a wall hinge part 4, 4′ and a wall attachment part 5, 5′, in each instance. Accordingly, the door hinge part comprises a door part 6 and a door attachment part 7.

The hinge axis S is defined by a pin 10 that passes through the wall hinge parts 4, 4′ and the door hinge part 6 into pin accommodations 8, 8′ and 9. Bearing bushings 11, 11′ and 12 made of a plastic material, for example, on the basis of POM with additives that modify the slide bearing, which has proven itself for use as a bearing bushing in door hinges, serve for mounting the pin 10 in the pin accommodations 8, 8′, 9. The bearing bushings 11, 11′, 12 have radial projections 13 that extend parallel to the hinge axis S. The diameter of the circle that connects the radial projections 13 with one another is adapted to the inside diameter of the pin accommodations 8, 8′, 9, in such a manner that the bearing bushings 11, 11′, 12 engage into the pin accommodation, in each instance, without play. Ring-shaped end regions 14 are formed onto the upper end of the bearing bushing 11 of the lower wall hinge part 2, onto the upper end of the bearing bushing 11 of the upper wall hinge part 1, and onto the lower end of the bearing bushing 12 of the door part 3; these regions project radially slightly beyond the radial projections 13. They rest in a correspondingly dimensioned radial widened region 15 of the pin accommodation 8, 8′, 9, in each instance, and thereby close off the pin accommodation to prevent penetration of contaminants from the outside. Furthermore, the end regions 14 of the bearing bushings 11′ of the lower wall part 2 and of the bearing bushing 12 of the door part 3 form supports, by way of which forces that act in the direction of the hinge axis are introduced from the door part 3 into the lower wall part 2. Furthermore, the bearing bushings 11, 11′, 12 have inner bores 16, the diameter of which is adapted to the diameter of the pin 10 in such a manner that the latter is accommodated by the bearing bushings 11, 12′, 12 so as to rotate, but essentially without play.

A bearing disk 17, the dimensions of which correspond to the end regions 14 and which is inserted into a radial widened part 15 of the lower wall part, forms the lower end of the lower wall part 2.

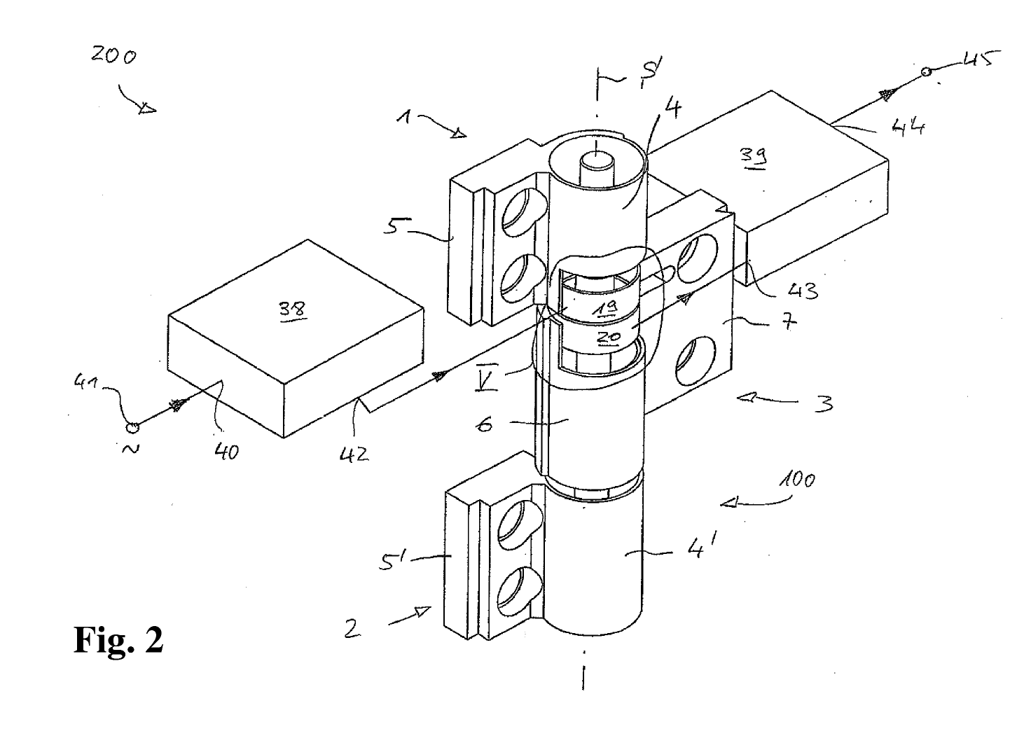

The length of the bearing bushing 11′ corresponds almost to the length of the pin accommodation 8′ of the lower wall part 2, while the bearing bushings 11, 12 are configured to be only about half as long as the pin accommodation 8 of the upper wall part or the pin accommodation 9 of the door part 3. A primary coil 19 and a secondary coil 20 are inserted into the free space of the pin accommodations 8, 9 that remains. A pressure spring 18, 18′ is situated, in each instance, between the primary coil 19 and the bearing bushing 11 as well as between the secondary coil 20 and the bearing bushing 12. These pressure springs provide that the two primary and secondary coils 19, 20 lie against one another with their face sides 21, 22, as can particularly be seen in FIGS. 2 and 5.

The primary coil 19 and the secondary coil 20 are configured identically, but are mounted in opposite directions with regard to the hinge axis S. They comprise a primary coil body 23 and a secondary coil body 24, which body comprises ferromagnetic or ferrimagnetic material. The coil bodies 23, 24 have a closed face wall 25, 26 on their sides that face one another, in each instance, which wall is perforated by a central passage bore 48, 48′, in each instance, for passage of the door hinge pin. An inner mantle wall 27, 28, in each instance, as well as an outer mantle wall 29, 30, in each instance, extend from the face walls 25, 26, concentric to the hinge axis S, in opposite directions. On the sides that lie opposite the face walls 25, 26, the coil bodies 23, 24 are open. The coil bodies can be made from plastic material in which ferrite particles are embedded, for example containing manganese-zinc ferrite.

In the interior of the coil bodies 24, 25, primary and secondary coil windings 31, 32 are situated, which are wound around the inner mantle walls 27, 28. High-frequency stranded wire is used for the coil windings.

An electrically non-conductive plastic material is injection-molded around the coil bodies 23, 24, with material fit.

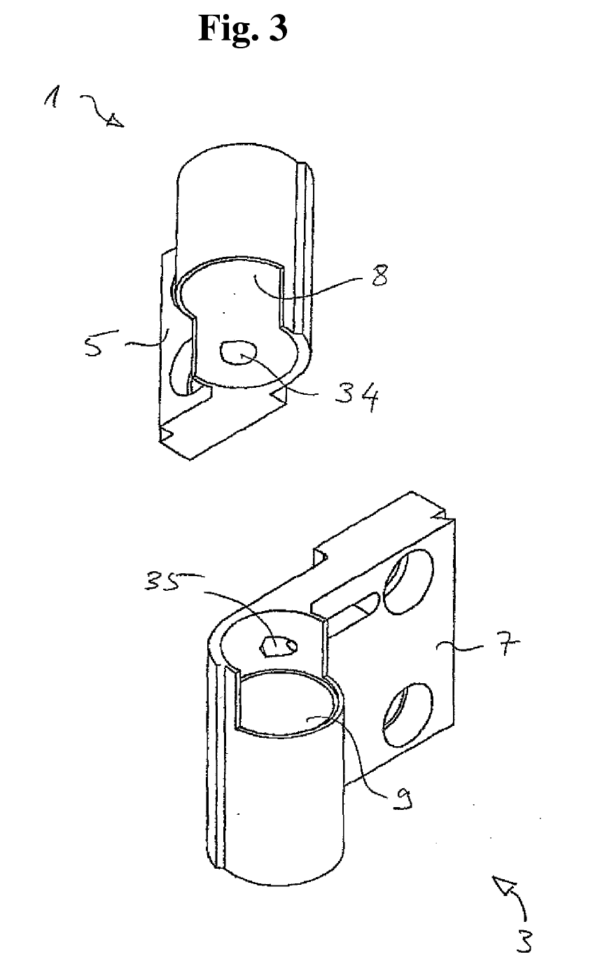

As can particularly be seen in FIGS. 1 and 3, channels 34, 35 are provided on the upper wall part 1 and on the door part 3, which channels extend from the door hinge pin accommodations 8, 9 into the frame attachment part 5 or the door attachment part 7. They serve for passing through connection lines 36, 37 of the primary and the secondary coil 19, 20, respectively.

In FIG. 2, a device 100 according to the present invention is shown, having primary electronics 38 and secondary electronics 39 to a system for transmission of electrical energy from a wall to a door attached to this wall. The primary electronics 38 of this system are connected, with their input 40, to a grid voltage 41. The primary electronics convert the grid voltage into a voltage of maximally 48 V and a frequency between 20 and 140 kHz, which is made available at the output 42. The latter is connected with the primary coil 19. However, it is also possible to provide an inverter in the primary electronics 38 so that the primary electronics can also be connected with a direct current source.

Because the primary and secondary coils 19, 20 are configured identically, approximately the same voltage is applied at the input 43 of the secondary electronics 39, which input is connected with the secondary coil 20, as at the output 42. In the secondary electronics 39, this voltage is converted into a voltage that is suitable for operation of an electrical consumer or electrical energy storage unit 45 that is connected at the output 44 of the secondary electronics 39.

In order to improve the inductive coupling between primary coil 19 and secondary coil 20, the pin 10 has a recess 46 that runs concentric to the hinge axis S. In this recess, there is a sleeve 47 made of a plastic material in which ferrite particles are embedded. The length of the sleeve 47 is dimensioned in such a manner that it agrees almost exactly with the length of the coil packet that consists of primary and secondary coil 19, 20.

The system according to the present invention was tested with the following experimental set-up: Coils having a coil winding of 50 windings of a high-frequency stranded wire having a diameter of 0.05 mm are used as primary and secondary coil 19, 20. The coil inductivity amounted to approximately 30 μH. The primary voltage made available using the primary electronics effectively amounted to about 5 V, with a primary frequency of 120 kHz. The secondary electronics were designed in such a manner that they made available a direct voltage of about 5 V at the output. It was possible to make a power of up to 750 mW available on the secondary side.

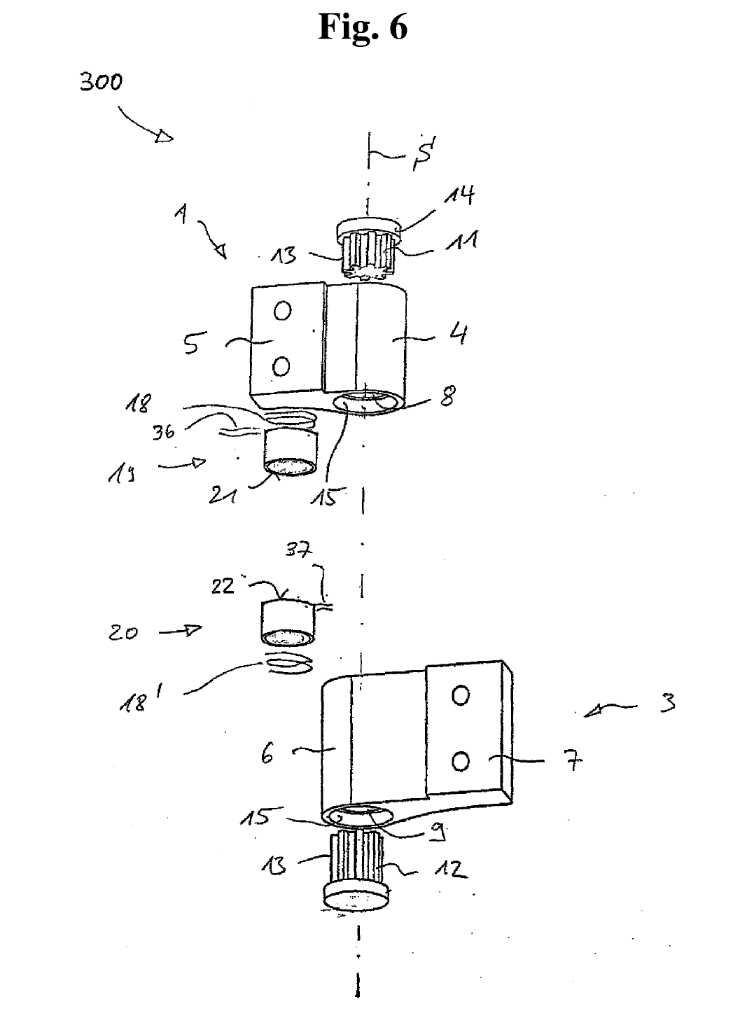

Another exemplary embodiment of a device 300 according to the present invention is shown in FIG. 6. The same reference numbers as for the device 100 were used for functionally equivalent components. To avoid repetition, reference is made to its description, above.

The device 300 serves exclusively for transmitting electric power from a wall part 1 to a door part 3. It is therefore always used in addition to conventional door hinges in the case of a wall/door arrangement.

In this device 300, the pin 10 is therefore absent. Accordingly, the bearing bushings 11, 12 are not provided with a bore. They are adapted to the recesses 8, 9 in such a manner that they can be pressed into them, producing a force fit, so that the pressure springs 18, 18′ can support themselves on the face sides that face one another.

The primary and secondary coils 19, 20 accordingly have coil bodies that, in contrast to the coil bodies in the device 100, do not have any central passage bore for passing the pin through, but rather are configured as a solid body there, made of ferromagnetic material.

When the device according to the present invention is affixed to a wall/door arrangement that comprises conventional door hinges, this is done in such a manner that the hinge parts 4, 6 do not make contact with one another with their faces sides that face one another, but rather a gap remains, which is bridged by the primary and secondary coils that are pressed against one another on the face side, under spring force. Because these coils can also be displaced crosswise to the hinge axis S, due to the absence of a pin that passes through them, adjustment of the door in the wall section can take place in all three spatial directions, without special adaptation of the device being required for this purpose.

The present invention is not limited to embodiments described herein; reference should be had to the appended claims.

### REFERENCE SYMBOL LIST

100, 300 device

200 system

1 upper wall part

2 lower wall part

3 door part

4, 4′ wall hinge part

5, 5′ wall attachment part

6 door hinge part

7 door attachment part

8, 8′ pin accommodation

9 pin accommodation

10 pin

11, 11′ bearing bushing

12 bearing bushing

13 projections

14 end regions

15 widened part

16 bores

17 bearing disk

18, 18′ pressure spring

19 primary coil

20 secondary coil

21 face side

22 face side

23 primary coil body

24 secondary coil body

25 face wall

26 face wall

27 inner mantle wall

28 inner mantle wall

29 outer mantle wall

30 outer mantle wall

31 primary coil winding

32 secondary coil winding

33 plastic material

34 channel

35 channel

36 connection line

37 connection line

38 primary electronics

39 secondary electronics

40 input

41 grid voltage

42 output

43 input

44 output

45 consumer/energy storage unit

46 recess

47 sleeve

48, 48′ passage bores

What is claimed is:

1-25. (canceled)

26. A method for transmitting electric power from a wall to a door hingeably attached to the wall about a hinge axis (S), the method comprising:
providing a primary coil on the wall;
providing a secondary coil on the door;
making available an electrical primary voltage on a wall side, the electrical primary voltage having a primary frequency that is suitable for acting on the primary coil; and
generating a secondary voltage of at least 500 mV in the secondary coil by an inductive coupling.

27. The method as recited in claim 26, wherein the primary frequency is greater than 20 kHz.

28. The method as recited in claim 26, wherein the primary frequency is between 50 and 140 kHz.

29. The method as recited in claim 26, wherein the electrical primary voltage is at most 48 V.

30. The method as recited in claim 26, wherein the electrical primary voltage is between 3.5 and 15 V.

31. The method as recited in claim 26, wherein the secondary voltage generated in the secondary coil is converted to an electrical operating voltage suitable for at least one of an electrical energy storage unit and an electrical consumer.

32. The method as recited in claim 26, further comprising converting a grid voltage to the electrical primary voltage on the wall side.

33. The method as recited in claim 26, further comprising converting a direct voltage to the electrical primary voltage on the wall side.

34. A device for transmitting electric power from a fixed wall to a door hingeably attached to the fixed wall about a hinge axis, the device comprising:
a wall part configured to be attached to the wall;
a door part configured to be attached to the door;
a primary coil disposed on the wall part comprising a coil face;
a secondary coil provided on the door part comprising a coil face;
wherein the primary coil and the secondary coil are suitable for frequencies of at least 20 kHz, and
wherein the primary coil and the secondary coil are arranged so that the coil face of the primary coil and the coil face of the secondary coil face each other and almost meet each other.

35. The device as recited in claim 34, wherein the primary coil comprises a primary coil winding and a primary coil body each having ferromagnetic or ferrimagnetic properties, and wherein the secondary coil comprises a secondary coil winding and a secondary coil body each having ferromagnetic or ferrimagnetic properties.

36. The device as recited in claim 35, wherein the primary coil body is configured to substantially cover the primary coil winding on a face side facing the door part and to be open on an opposite side, and the secondary coil body is configured to substantially cover the secondary coil winding on a face side facing the wall part and to be open on an opposite side.

37. The device as recited in claim 35, wherein at least one of the primary coil body and the secondary coil body comprises an inner cylindrical mantle wall, around which the respective primary coil winding and secondary coil winding are wound.

38. The device as recited in claim 37, wherein at least one of the primary coil body and the secondary coil body comprises an outer mantle wall which is arranged concentric to the inner cylindrical mantle wall.

39. The device as recited in claim 35, wherein the primary coil winding and the secondary coil winding consist of a high-frequency stranded wire.

40. The device as recited in claim 35, further comprising a pin configured to define the hinge axis, wherein the primary coil body and the secondary coil body each comprise an opening configured to extend approximately concentric to the inner cylindrical mantle wall in a direction of the hinge axis, the opening being configured so as to have the pin be insertable therethrough.

41. The device as recited in claim 40, wherein the pin comprises a sleeve with ferromagnetic or ferrimagnetic properties on a length covered by the primary coil and by the secondary coil.

42. The device as recited in claim 41, wherein the pin comprises a recess that runs concentric to a longitudinal axis of the pin, and wherein the sleeve is provided in the recess.

43. The device as recited in claim 41, wherein the sleeve is produced from a plastic material comprising ferrite particles.

44. The device as recited in claim 34, wherein at least one of the primary coil and the secondary coil is mounted spring-loaded in the wall part or the door part so as to be displaceable against the other respective primary coil or secondary coil in a direction of the hinge axis.

45. The device as recited in claim 34, wherein a length of at least one of the primary coil and the secondary coil in a direction of the hinge axis is smaller than an outside diameter of a respective coil housing of the primary coil or of the secondary coil.

46. The device as recited in claim 34, wherein the primary coil and the secondary coil are configured identically.

47. The device as recited in claim 34, wherein at least one of the primary coil and the secondary coil have an inductivity of between 1 μH and 100 μH.

48. The device as recited in claim 47, wherein the inductivity is approximately 30 μH.

49. The device as recited in claim 34, wherein the primary coil and the secondary coil are configured to have an effective maximum voltage of 48 V.

50. The device as recited in claim 34, wherein at least one of the primary coil and the secondary coil are sheathed by a form-fitting electrically insulating material.

51. The device as recited in claim 34, wherein the respective coil faces of the primary coil and of the secondary coil facing each other are sheathed by a form-fitting electrically insulating material.
